(19) United States
(12) Patent Application Publication
(10) Pub. No.: US 2012/0044681 A1
(43) Pub. Date: Feb. 23, 2012

(54) Illuminating device of light emitting diode (LED) wafer holder

(76) Inventor: Ming Liang LIN, Dongguan City (CN)

(21) Appl. No.: 13/197,218

(22) Filed: Aug. 3, 2011

(30) Foreign Application Priority Data
Aug. 18, 2010 (CN) 201020298146.6

(51) Int. Cl. F21V 1/00

(52) U.S. Cl. 362/235

(57) ABSTRACT

This invention relates to the technical field of electronic components, and in particular to an improved illuminating device of light emitting diode (LED) wafer holder. The improved illuminating device of LED wafer holder comprises a reflecting shade and a diode crystal holder, wherein the diode crystal holder comprises a plurality of electrode portions and isolation portions disposed between the electrode portions; a plurality of crystals are disposed on the upper end of the electrode portion; a connecting piece with functions of radiation and conduction is fixedly set between one crystal and another; the diode crystal holder is connected with three non-polar brackets; the reflecting shade is internally provided with a plastic sheet which is opened with air holes; the inner wall of the plastic sheet is provided with fluorescent powder. This invention arranges the connecting piece between one crystal and another by means of the principle of mechanical structure to replace the conventional lead welding; furthermore, due to the air holes opened on the plastic sheet inside the reflecting shade, the deterioration of fluorescent powder and silica gel can be avoided, the problems of light source attenuation, lead floating and lead short circuit can be overcome and the service life can be extended.

### FIELD OF THE INVENTION

This invention relates to the technical field of electronic components, and in particular to an improved illuminating device of light emitting diode (LED) wafer holder.

### BACKGROUND OF THE INVENTION

At present, LED is applied to various illuminating apparatuses, with a main assembly mode of lead frame connection. Generally, it includes two lead frames with fixed polarity; the upper end of the lead frame is provided with a crystal holder comprising a plurality of electrode portions between which isolation portions are disposed; a plurality of crystals are disposed on the electrode portion; the crystals are connected through a lead by welding the frame, the electrode portion, the positive electrode and negative electrode of each crystal. Since false solder or solder skip may occur to the positive electrode and negative electrode of the crystal during the lead welding process due to various reasons, a poor contact may be caused to the whole connection circuit, thereby influencing quality. Furthermore, if a wrong connection is found after the positive electrode and negative electrode of the crystal are welded, it has to conduct fusion welding to the welding joint of the electronic components of the lead and the crystal before re-welding; this process not only damages crystal but also brings inconvenience to processing and dismounting; in addition, since the temperature held by the crystal is very high, the fluorescent power and silica gel will deteriorate due to many accumulated heat sources after a long term of usage of electronic components, thereby resulting in LED light source attenuation, lead floating and lead short circuit and finally influencing the service life of light source.

### SUMMARY OF THE INVENTION

Considering the defects of the prior art, the purpose of the invention is to provide an improved illuminating device of LED wafer holder, which replaces the lead welding, has no damage to crystals, avoids the problems of light source attenuation, lead floating and lead short circuit, and is convenient to process and dismount, with radiation function and long service life.

In order to achieve the purpose above, the invention adopts the following technical scheme: an improved illuminating device of LED wafer holder, comprising a reflecting shade and a diode crystal holder, wherein the diode crystal holder comprises a plurality of electrode portions and isolation portions disposed between the electrode portions; a plurality of crystals are disposed on the upper end of the electrode portion; a connecting piece with functions of radiation and conduction is fixedly set between one crystal and another; the diode crystal holder is connected with three non-polar brackets; the reflecting shade is internally provided with a plastic sheet which is opened with air holes; the inner wall of the plastic sheet is provided with fluorescent powder.

The connecting piece is a straight sheet whose two ends are provided with connecting holes, the crystal is provided with connecting posts, wherein the connecting holes are connected with the connecting posts of the crystal.

The connecting hole is a U shaped hole, a V shaped hole or a circular hole.

The connecting piece is a copper sheet conductor or an aluminum sheet conductor.

The lower end of the diode crystal holder is provided with a radiation device.

The electrode portion is a circular structure or a laminated columnar structure, which is circular, oblate or polygonal in the shape.

The advantages of the invention are that: the invention comprises a reflecting shade and a diode crystal holder, wherein the diode crystal holder comprises a plurality of electrode portions and isolation portions disposed between the electrode portions; a plurality of crystals are disposed on the upper end of the electrode portion; a connecting piece with functions of radiation and conduction is fixedly set between the one crystal and another; the diode crystal holder is connected with three non-polar brackets; the reflecting shade is internally provided with a plastic sheet which is opened with air holes; the inner wall of the plastic sheet is provided with fluorescent powder. The invention arranges the connecting piece between one crystal and another by means of the principle of mechanical structure, enabling the positive electrode and negative electrode of each crystal to be connected in sequence, thereby being capable of replacing the conventional lead welding, being convenient to process and dismount and causing no damage to crystals. The connecting piece is further provided with a radiation function, which facilitates the effective radiations of the electrode portions, each crystal and the connecting piece itself; the reflecting shade is internally provided with a plastic sheet whose inner wall is provided with fluorescent powder; since the plastic sheet is further provided with air holes, it can avoid the deterioration of fluorescent powder and silica gel, the problems of light source attenuation, lead floating and lead short circuit, extend the service lives of the LED crystal holder entirety, each crystal and the connecting piece itself. In addition, the three non-polar brackets connected with the LED crystal holder have no positive or negative polarity, when being used, any two brackets can be connected; positive and negative electrodes can be automatically selected between the two connected brackets.

### BRIEF DESCRIPTION OF THE DRAWINGS

FIG. 1 shows a schematic diagram of a structure according to Embodiment 1 of the invention;

FIG. 2 shows a schematic diagram of a connection of the crystal and the connecting piece according to Embodiment 1 of the invention; and

FIG. 3 shows a schematic diagram of a structure according to Embodiment 2 of the Invention.

### DETAILED DESCRIPTION OF THE INVENTION

The invention is described in detail with reference to the accompanying drawings hereinafter.

### Embodiment 1

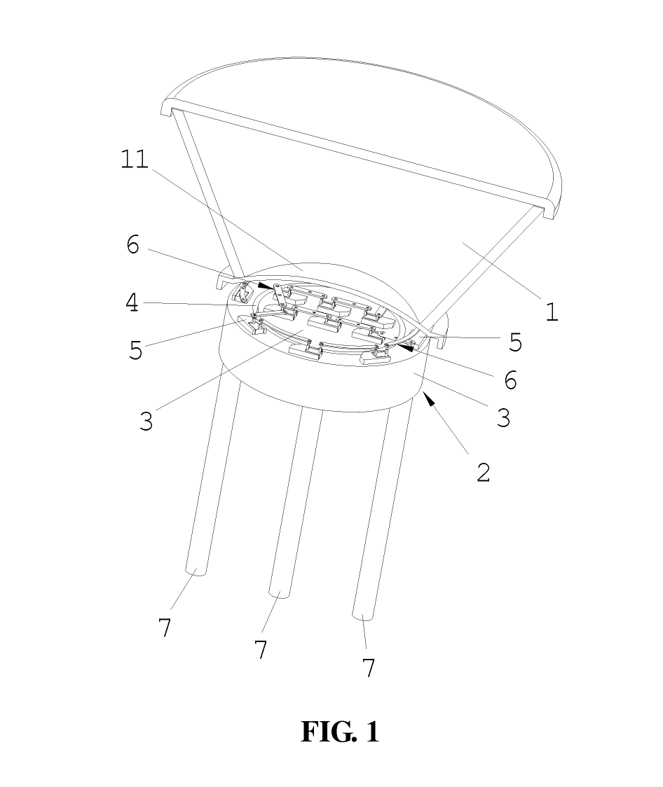

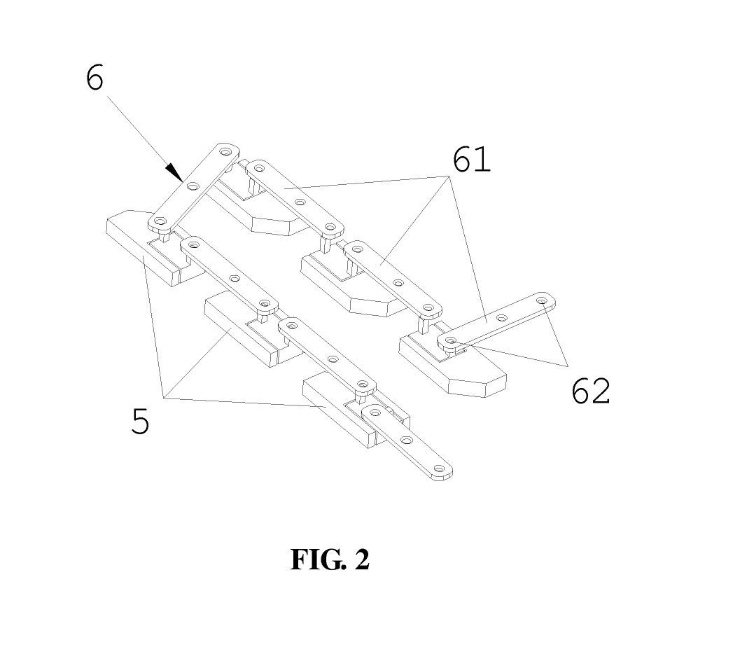

As shown in FIG. 1 and FIG. 2, an improved illuminating device of LED wafer holder comprises a reflecting shade 1 and a diode crystal holder 2, wherein the diode crystal holder 2 comprises a plurality of electrode portions 3 which are of circular structures that can be circular and oblate in the whole shape or can be polygon columnar structures, and isolation portions 4 disposed between the electrode portions 3; a plurality of crystals 5 are disposed on the upper end of the electrode portion, wherein the crystals 5 can be disposed on one electrode portion 3 or on a plurality of electrode portions 3 simultaneously; a connecting piece 6 with functions of radiation and conduction is fixedly set between one crystal 5 and another; the diode crystal holder 2 is connected with three non-polar brackets 7, wherein the connecting piece 6 connects the positive electrode and negative electrode of each crystal 5 into a return circuit, which replaces the welding mode and is convenient to process and dismount and has no damage to electrode portions 3; the non-polar bracket 7 has no positive or negative electrode, when being used, any two brackets 7 can be connected; the positive and negative electrodes can be automatically selected between the two connected brackets.

The reflecting shade 1 is internally provided with a plastic sheet 11 whose inner wall is provided with fluorescent powder; the plastic sheet 11 is opened with air holes which have a distance from the crystals 5 and can effectively dissipate the heat of the crystals 5 and plastic sheet 11, thereby protecting crystals 5 and preventing the deterioration of fluorescent powder and silica gel, reducing light attenuation and guaranteeing the service life of light source.

In the embodiment, the middle part of the connecting piece 6 is a straight sheet 61 whose two ends are provided with connecting holes 62, the crystal 5 is provided with connecting posts, wherein the connecting holes 62 are connected with the connecting posts of the crystal 5; the connecting holes 62 on the two ends of the straight sheet 61 are connected with the positive electrode or negative electrode of the crystal 5; the straight sheet 61 and the connecting hole 62 consist of a connecting piece 6 of mechanical structure which can fixedly connect the positive electrode or negative electrode of each crystal 5 conveniently and at the same time can effectively dissipate the heat of the electrode portion 3 entirety, each crystal 5 and the connecting piece 6 itself to extend the service lives thereof.

In the embodiment, the electric conductor is a copper sheet preferably, or maybe an aluminum sheet or the other electrode portions 3 of conductive sponge or conductive rubber, only if it is good for the conduction of each crystal 5, convenient to dismount and process and convenient for the realization of mechanical principle.

In the embodiment, the connecting holes 62 set on the two ends of the straight sheet 61 are both circular holes, also can be U shaped holes or V shaped holes; the connecting holes 62 set on the two ends of the straight sheet 61 maybe a circular hole on one end and a U shaped hole on the other end, also can be a circular hole on one end and a V shaped hole on the other end, or a U shaped hole on one end and a V shaped hole on the other end, only if it can fixedly connect the positive electrode or negative electrode of each crystal 5 and is convenient to dismount and process.

In the embodiment, the lower end of the LED crystal holder 2 is provided with a radiation device which is mainly used for exporting the heat of each component of the invention so as to keep the heat within a range of temperature.

When manufacturing the invention, electrode portions 3 and isolation portions 4 of the LED crystal holder 2 are assembled first; then each crystal 5 is disposed on the upper end of the electrode portion 3 of the LED crystal holder 2; the connecting piece 6 is connected between the positive electrode and negative electrode of each crystal 5 by means of the mechanical structure principle of fixing device to conduct each crystal 5, thereby replacing the conventional lead welding, being convenient to process and dismount and causing no damage to crystals 5; besides, the connecting piece 6 is provided with a radiation function, which facilitates the effective radiation of electrode portion 3, each crystal 5 and the connecting piece 6 itself, thereby extending the service lives thereof; then, three non-polar brackets 7 are provided on the lower end of the electrode portion 3 and connected therewith; a plastic sheet 11 is covered on the crystal 5; the inner wall of the plastic sheet 11 is provided with fluorescent powder; air holes are set on the plastic sheet 11, wherein the air holes can effectively dissipate the heat of the fluorescent powder on the inner wall of the plastic sheet 11; the air holes, cooperated with the connecting piece 6 with radiation function, effectively dissipate the heat of crystal 5; finally, a reflecting shade 1 is arranged outside the plastic sheet 11 and crystal 5, for enhancing the luminance brightness of illumination.

Furthermore, the connecting piece 6 of mechanical structure principle also can manufacture the fluorescent powder on the plastic pre-determinedly, for replacing the prior art in which fluorescent powder is directly dispensed on the crystals 5; crystals 5 can be designed to be one color or different colors depending on actual need, thereby achieving the requirement of chromaticity uniformity or diversification of the invention and the crystals 5 on the electrode portions 3 of the LED crystal holder 2.

### Embodiment 2

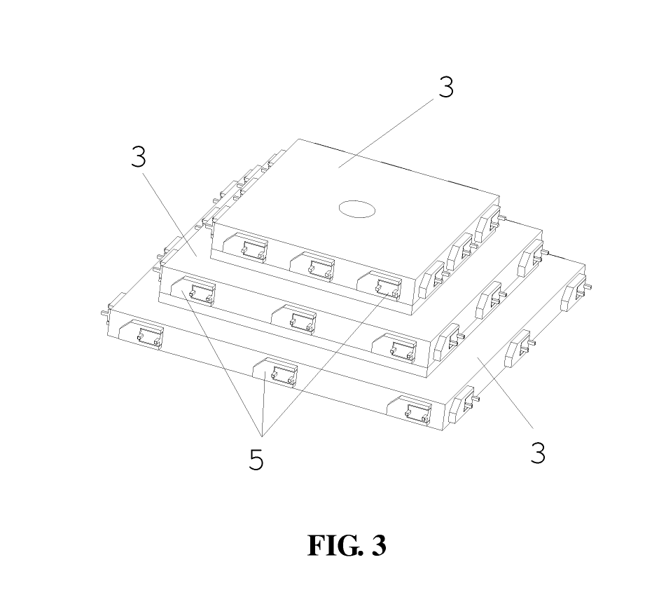

As shown in FIG. 3, is different from Embodiment 1 in that: the LED crystal holder 2 is provided with a plurality of electrode portions 3 each being an independent power source; the plurality of electrode portions 3 are of laminated columnar structures which can be circular and oblate in the whole shape or can be polygonal structures; each electrode portion 3 is provided with a plurality of crystals 5; different electrode portions 3 can be designed to be one color or different colors depending on actual need; since a plastic sheet 11 is covered on the crystal 5, air holes are set on the plastic sheet 11 and fluorescent powder is set on the inner wall of the plastic sheet 11, the brightness and chromaticity of the invention is improved, the heat of crystals 5 and plastic sheet 11 is effectively dissipated, thereby being good for protecting crystals 5, preventing the deterioration of fluorescent powder and silica gel, reducing light attenuation and guaranteeing the service life of light source.

The above is only the preferred embodiments of the invention, any equivalent changes or modifications made according to the construction, feature and structure within the scope of the invention are deemed to be included within the scope of the utility mode.

What is claimed is:

1. An improved illuminating device of light emitting diode (LED) wafer holder, comprising a reflecting shade (1) and a diode crystal holder (2), wherein the diode crystal holder (2) comprises a plurality of electrode portions (3) and isolation portions (4) disposed between the electrode portions (3); a plurality of crystals (5) are disposed on the upper end of the electrode portion (3); a connecting piece (6) with functions of radiation and conduction is fixedly set between one crystal (5) and another; the diode crystal holder (2) is connected with three non-polar brackets (7); the reflecting shade (1) is internally provided with a plastic sheet (11) which is opened with air holes; the inner wall of the plastic sheet (11) is provided with fluorescent powder.

2. The improved illuminating device of LED wafer holder according to claim 1, wherein the connecting piece (6) is a straight sheet (61) whose two ends are provided with connecting holes (62); the crystal (5) is provided with connecting posts which are connected with the connecting holes (62).

3. The improved illuminating device of LED wafer holder according to claim 2, wherein the connecting hole (62) is a U shaped hole, a V shaped hole or a circular hole.

4. The improved illuminating device of LED wafer holder according to claim 3, wherein the connecting piece (6) is a copper sheet conductor or an aluminum sheet conductor.

5. The improved illuminating device of LED wafer holder according to claim 1, wherein the lower end of the diode crystal holder (2) is provided with a radiation device.

6. The improved illuminating device of LED wafer holder according to claim 1, wherein the electrode portion (3) is a circular structure or a laminated columnar structure, which is circular, oblate or polygonal in the shape.
